(19) United States
(12) Patent Application Publication
(10) Pub. No.: US 2024/0007809 A1
(43) Pub. Date: Jan. 4, 2024

(54) MICROPHONE CALIBRATION METHOD, IN PARTICULAR MICROPHONE FOR AERONAUTICAL USE

(71) Applicant: LEONARDO S.P.A., ROMA (IT)

(72) Inventor: Felice Menafro, Torino (IT)

(21) Appl. No.: 18/037,812

(22) PCT Filed: Nov. 25, 2021
(86) PCT No.: PCT/IB2021/060983

§ 371 Date: May 19, 2023

(30) Foreign Application Priority Data
Nov. 25, 2020 (IT) 102020000028430

(51) Int. Cl. H04R 29/00

(52) U.S. Cl. CPC H04R 29/004

(57) ABSTRACT

A microphone calibration method, in particular a microphone for aeronautical use, comprising the following steps, coupling a reference microphone to a first end of a first standing-wave tube; coupling a microphone subjected to calibration to a first end CI a) of a second standing-wave tube; supplying an acoustic input signal to the second end of the first and second tubes so that plane standing-waves propagate in the tubes; measuring the sound pressure of the acoustic signal detected by the first and second microphones; increasing the sound pressure of the acoustic input signal from an initial value until a first sound pressure value DB1r is measured by means of the reference microphone and simultaneously detecting a first sound pressure value DB1t by means of the microphone subjected to calibration; further increasing the sound pressure of the acoustic input signal by a first amount ΔDB1 and detecting a second sound pressure value DB2r by means of the reference microphone and simultaneously detecting a second sound pressure value DB2t by means of the microphone subjected to calibration; decreasing the sound pressure of the acoustic input signal by a second amount −ΔDB2 greater than the first amount ΔDB1 and detecting a third sound pressure value DB3r by means of the reference microphone and simultaneously detecting a third sound pressure value DB3t by means of the microphone subjected to calibration; again, increasing the sound pressure of the acoustic input signal by a third amount ΔDB3 and detecting a fourth sound pressure value by means of the reference microphone and simultaneously detecting a fourth sound pressure value with the microphone subjected to calibration; the sum of the first and third amounts corresponding to the absolute value of the second amount; controlling whether the fourth sound pressure value detected by means of the microphone subjected to calibration substantially corresponds to the first sound pressure value DB1t by means of the same microphone subjected to calibration and in the case of a positive outcome detecting a correct calibration of the microphone.

### CROSS-REFERENCE TO RELATED APPLICATIONS

This patent application claims priority from Italian patent application no. 102020000028430 filed on Nov. 25, 2020, the entire disclosure of which is incorporated herein by reference.

### TECHNICAL FIELD

The present invention relates to a microphone calibration method, in particular microphone for aeronautical use.

### BACKGROUND OF THE INVENTION

Currently, the most reliable method for microphone calibration is the Rayleigh “Reciprocity” technique (IEC 61094-2).

Standard 61094-2 is the Italian version of the European Standard CENELEC EN 61094-2, identical to Publication IEC 1094-2 and applies to laboratory sample microphones conforming to the requirements of Publication IEC 1094-1 and to other types of condenser microphones having the same mechanical dimensions; it also specifies a primary method for determining pressure sensitivity in order to establish a reproducible and accurate basis for measuring acoustic pressure.

Such a method makes use of pairs or triplets of only microphone capsules (at least one of which is more performing and serves as a reference, and the other belonging to the same family to be subjected to calibration) coupled face-to-face in a small cavity which alternately act as generators and meters of acoustic waves, providing the sensitivity of the microphone (e.g., 50 mV/Pa) under various test conditions.
This calibration method is mainly used in national primary metrological institutes and is less used in industry because it is time-consuming and delicate to implement. Calibration methods are described in patent application U.S. Ser. No. 10/519,033B2, WO2019077231A1, U.S. Ser. No. 10/520,356B2, U.S. Pat. No. 5,567,863, CN 111 510 840 and CN 102 655 628.

### Subject of the Invention

The aim of the present invention is to develop a new method for microphone calibration, which is accurate and robust and suitable for application in the industrial field, in particular in the aeronautical industry.

### Aim of the Present Invention

The preceding object is achieved by the present invention in that it relates to a calibration method of the type embodied in claim 1.

### DESCRIPTION OF THE FIGURES

FIG. 1 illustrates a calibration apparatus 1 implementing the method of the present invention;

FIG. 2 illustrates a detail of the apparatus in FIG. 1; and

FIG. 3 illustrates a flow chart summarising the calibration operations carried out.

### Preferred Description of the Invention

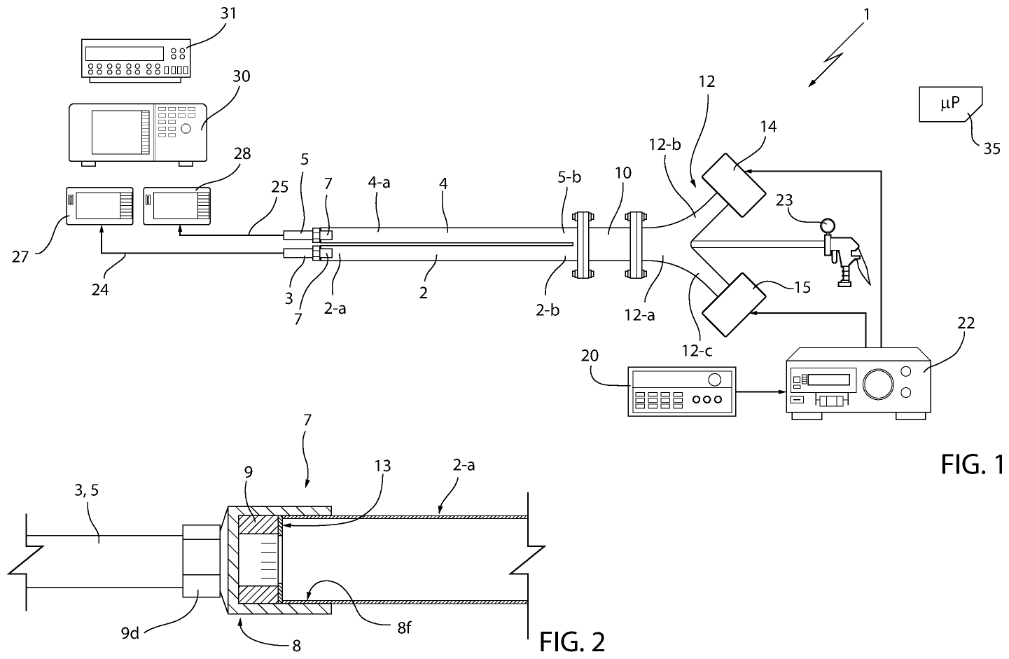

FIG. 1 illustrates a calibration apparatus 1 implementing the method of the present invention.

Such a calibration apparatus 1 comprises:

a first standing-wave tube 2 having a first end 2-a carrying

a reference microphone 3 and a second end 2-b configured to receive an acoustic input signal; and

a second standing-wave tube 4 having a first end 4-a carrying a microphone 5 subjected to calibration and a second end 5-b configured to receive the acoustic input signal.
In the example shown, the tubes 2 and 4 have a straight cylindrical shape and are placed side-by-side. For example, the tubes 2 and 4 are made of steel, both are approximately 1 m long and have an internal diameter of 30 mm and an external diameter of 38 mm.
Each microphone 3, 5 is carried by a plug 7 (plug-in stand) shaped to support the microphone and arranged to close the respective ends 2-a and 2-b.
The plug (FIG. 2) 7 consists of a cup-like body 8 provided with an internal thread 8f adapted to couple with a thread made on the external surface of the end 2-a. The cup-like body 8 carries a Teflon ring 9 with an internal diameter equal to the external diameter of the microphone body 3,5 which is carried by the ring 9; a flat, circular-crown shaped steel washer 13 covers the side of the Teflon ring 9 facing the tube 2 and 4 and simulates a reflecting surface.

A hole is drilled at the end of the cup-like body to accommodate a portion of the microphone 3,5 protruding from the cup-like body, while a rubberised nut 9d tightens the collar of the microphone to lock it in place.
The second ends 2-b, 4-b (FIG. 1) are connected through a fitting 10 with a Y-tube 12 having a central arm 12-a connected with the fitting 10 and each of the ends arranged at the end of the respective diverging arms 12-b, 12-c carries a sound source 14, 15 made by a speaker (of known type). The fitting 10 adapts on one side the single-diameter circular profile of the Y-tube 12 with a two-diameter profile of the first and second standing-wave tubes 2 and 4. The fitting 10 makes an “exponential trumpet” (Schaum Theory of Acoustic-W.Seto, Ch. 5) of a known type. The functions of an exponential trumpet are described, for example, in the text “Exponential Horn-Schaum Theory and Problem of Acoustic” Mc Graw Hill Book Company.

To be precise, the optimised length of the fitting 10 applies:

L=1n(D/de)·C/(2π·fmin).

Where D is the diameter of the source conduit 12-a, de the equivalent feed conduit (first and second tube 2 and 4)

fₘᵢₙ is a minimum frequency; and

C represents the sound propagation speed in the medium (air 343 m/s).
Plane standing-waves propagate inside the tubes 2 and 4. As known, they are characterised in that in each section orthogonal to the propagation direction (tube axis in this case), the speed of the air particles and the pressure are uniform at each instant and vary periodically in time.
The speakers 14, 15 are adapted to make frequencies within a range (e.g., 10 Hz-20,000.00 Hz) wherein the microphones 3 and 5 operate.
The apparatus 1 comprises a signal generator 20 which is connected in output to the speakers 14 and 15 through an amplifier 22 whose output power may be adjusted remotely. The amplifier 22 has low harmonic distortion. One of the parameters for evaluating the excellence of an amplifier is THD, the amplifier 22 in question should have a THD<0.1% https://en.wikipedia.org/wiki/Total_harmonic distortion),
The signal generator 20 (of known type) is configured to produce an output signal with a high level of tonal purity, controllable in frequency, amplitude and optionally in phase. The signal generator 20 produces a signal with a sinusoidal waveform.

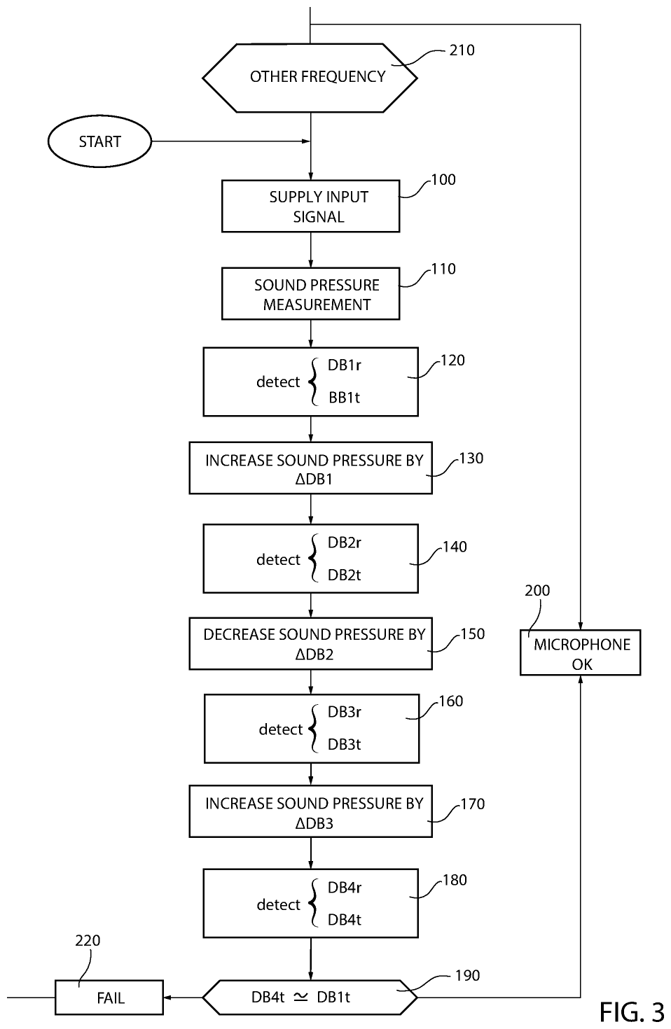

A device 23 may be provided which is adapted to adjust the pressure of the gases (air) present inside the first and second tubes 2 and 4 to simulate the condition of decreasing atmospheric pressure which occurs during the flight of an aircraft.
The microphone 3 and the microphone 5 are connected by means of shielded cables 24, 25 with inputs of respective preamplifiers 27, 28 connected at the output with a spectrum analyser 30 (used to measure tone purity) any distortions, the measuring incidence at rotation/coupling and a frequency meter 31 (used to measure the fundamental). The spectrum analyser is also used to measure the sound pressure.
   As is well known, sound pressure (SPL=sound pressure level) is the change in dynamic pressure of elastic wave fronts in the medium (air) measured in dB (ref 20 uPa).
The calibration apparatus 1 operates under the control of a computer 35 which controls the sinusoidal signal generator 20, the amplifier 22 and communicates with the microphones 3 and 5 and with the spectrum analyser 30 and the frequency meter 31 to analyse the signal detected by the microphones 3, 5.
The apparatus 1 controlled by the computer 30 carries out the following steps (FIG. 3):

The signal generator 20 (block 100) is activated and the power of the amplifier 22 is set so as to provide, at the second end of the first and second tubes 2, 4, a sinusoidal acoustic input signal having a defined frequency and sound pressure;

The sound pressure (block 110) detected by the first and second microphones 3, 5 is measured;

The computer acts on the amplifier 22 so as to make the sound pressure of the acoustic input signal increase from an initial value until a first target sound pressure value DB1r (e.g., 94.0 dB) is measured by means of the reference microphone 3 and simultaneously a first sound pressure value Dint is measured by the microphone 5 subjected to calibration (block 120);

The computer acts on the amplifier 22 so as to further increase the sound pressure of the acoustic input signal by a first amount ΔDB1 (e.g., +20 dB—block 130) and detects a second sound pressure value DB2r by means of the reference microphone 3 and simultaneously detects (block 140) a second sound pressure value DB2t by means of the microphone subjected to calibration 5;

The computer acts on the amplifier 22 so as to decrease the sound pressure of the acoustic input signal (block 150) by a second amount −ΔDB2 (e.g., −40 dB) greater than the first LDB1 and detects a third sound pressure value DB3r by means of the reference microphone 3 and simultaneously detects a third sound pressure value DB3t by means of the microphone subjected to calibration 5 (block 160);

again increases the sound pressure of the acoustic input signal by a third amount LDB3 (e.g., +20 dB—block 170) and detects a fourth sound pressure value Db4r by means of said reference microphone 3 and simultaneously detects a fourth sound pressure value Db4t by means of the microphone subjected to calibration 5 (block 180);

the sum of the first and third amounts corresponding to the absolute value of the second amount; The computer 35 controls whether the fourth sound pressure value DB4t detected by the microphone subjected to calibration 5 substantially corresponds to the first sound pressure value DB1t also detected by the microphone subjected to calibration 5 (block 190), and in the case of a positive outcome, detects a correct calibration of the microphone 5 (block 200) for the frequency of the signal used.

The previous operations are repeated cyclically (block 210) for different frequencies in order to detect the correct calibration of the microphone throughout the reference frequency range.

If the operations of block 190 are unsuccessful, a fail is detected for the microphone being calibrated and the above operations are repeated for a different frequency.

The operations of the flow chart in FIG. 3 are repeated after varying the pressure in the standing-wave tubes 2,4 to evaluate the operation of the microphone 3 at different altitudes.

1. A microphone calibration method, in particular microphone for aeronautical use, comprising the following steps
A) coupling a reference microphone (3) to a first end (2-a) of a first standing-wave tube (2);
B) coupling a microphone subjected to calibration (5) to a first end (4-a) of a second standing-wave tube (4);
C) supplying, to the second end of the first and second tubes, an acoustic input signal so that the plane standing-waves propagate in the tubes;
D) measuring the sound pressure of the acoustic signal detected by the first and second microphones (3,5);
E) increasing the sound pressure of the acoustic input signal by an initial value until a first sound pressure value DB1r is measured by means of said reference microphone (3) and simultaneously detecting a first sound pressure value DB1t by means of the microphone subjected to calibration (5);
F) furthermore increasing the sound pressure of the acoustic input signal by a first amount ΔDB1 and detecting a second sound pressure value DB2r by means of said reference microphone (3) and simultaneously detecting a second sound pressure value DB2t by means of the microphone subjected to calibration;
G) decreasing the sound pressure of the acoustic input signal by a second amount −ΔDB2 greater than the first amount ΔDB1 and detecting a third sound pressure value DB3r by means of said reference microphone (3) and simultaneously detecting a third sound pressure value DB3t by means of the microphone subjected to calibration (5);
H) again, increasing the sound pressure of the acoustic input signal by a third amount ΔDB3 and detecting a fourth sound pressure value DB4r by means of said reference microphone (3) and simultaneously detecting a fourth sound pressure value DB3t by means of the microphone subjected to calibration (5);
the sum of the first and third amounts corresponding to the absolute value of the second amount;
I) controlling whether the fourth sound pressure value DB3t, detected by means of the microphone subjected to calibration, substantially corresponds to the first sound pressure value DB1t by means of the same microphone subjected to calibration and in the case of a positive outcome detecting a correct calibration of the microphone.

2. The method according to claim 1, wherein the steps C)-I) are repeated for different frequencies of the acoustic signal.

3. The method according to claim 1, wherein the second amount is double the first and the third amounts.

4. The method according to claim 1 wherein the steps C)-I) are repeated after varying the gas pressure inside said standing-wave tube to simulate the operation of the microphones at different altitudes.
